(19) United States
(12) Patent Application Publication
(10) Pub. No.: US 2025/0353524 A1
(43) Pub. Date: Nov. 20, 2025

(54) APPARATUS AND METHOD FOR GENERATING A DRIVING ENVIRONMENT MAP FOR AUTONOMOUS DRIVING

(71) Applicant: ELECTRONICS AND TELECOMMUNICATIONS RESEARCH INSTITUTE, Daejeon (KR)

(72) Inventors: DooSeop Choi, Daejeon (KR); Kyoung-Wook Min, Daejeon (KR); KYOUNG HWAN AN, Daejeon (KR)

(21) Appl. No.: 19/184,072

(22) Filed: Apr. 21, 2025

(30) Foreign Application Priority Data
May 14, 2024 (KR) 10-2024-0063158
Apr. 11, 2025 (KR) 10-2025-0047470

(51) Int. Cl. B60W 60/00; B60W 50/00; G01C 21/00

(52) U.S. Cl. CPC B60W 60/001; B60W 50/0097; G01C 21/3848; B60W 2420/403; B60W 2520/06; B60W 2554/20; B60W 2556/40; B60W 2556/50

(57) ABSTRACT

The present invention relates to an apparatus and method for generating a map representing a driving environment of an autonomous vehicle using an artificial neural network. The driving environment map generation apparatus for autonomous driving includes: a current position and orientation prediction unit configured to predict the current position information and heading direction information of the autonomous vehicle using sensors mounted on the autonomous vehicle; a static object information returning unit configured to receive static object information from a commercial navigation system; a static object information preprocessing unit configured to perform preprocessing on the static object information; and an occupancy grid map prediction unit configured to predict an occupancy grid map by using the preprocessed static object information and information acquired by a camera mounted on the autonomous vehicle.

### CROSS-REFERENCE TO RELATED APPLICATION(S)

This application claims priority from and the benefit of Korean Patent Application Nos. 10-2024-0063158, filed on May 14, 2024 and 10-2025-0047470, filed on Apr. 11, 2025, which are hereby incorporated by reference for all purposes as if set forth herein.

### BACKGROUND

### 1. Technical Field

The present invention relates to an apparatus and a method for generating a map representing the driving environment of an autonomous vehicle using an artificial neural network.

### 2. Description of Related Art

Autonomous driving systems utilizing high-definition (HD) maps can make driving decisions without explicitly representing elements such as “drivable areas” or “lane markings” on an occupancy grid map (OGM), by pre-constructing detailed information about road structures and lanes with high precision. However, constructing and maintaining HD maps on a nationwide scale requires substantial cost and time, and the HD map may lose its up-to-dateness when real-time road structures change due to road construction, emergency rescue activities, or temporary lane changes, thereby degrading the reliability of autonomous driving decisions. Accordingly, artificial intelligence technologies capable of dynamically recognizing road environments based on real-time sensor data are in demand, and occupancy grid map prediction technology using a query map-based transformer is attracting attention as an alternative.

However, camera sensors mounted on autonomous vehicles generally do not support high-resolution imaging in order to prevent computational delays, which limits the prediction accuracy for distant static objects. In addition, in occluded areas caused by surrounding vehicles or objects, it is difficult to reliably determine the presence of static objects using only camera-based information.

### SUMMARY

The present invention has been proposed to address the aforementioned problems, and its objective is to provide a neural network architecture that generates, in real time, an occupancy grid map (OGM) representing the driving environment by using navigation map information and camera data from the autonomous vehicle.

An apparatus for generating a driving environment map for autonomous driving according to the present invention includes: a vehicle position and orientation prediction unit configured to predict current position information and heading direction of an autonomous vehicle using sensors mounted on the autonomous vehicle; an autonomous vehicle surrounding static object information return unit configured to receive static object information from a commercial navigation system; a static object information preprocessing unit configured to perform preprocessing on the static object information; and an occupancy grid map prediction unit configured to predict an occupancy grid map using the preprocessed static object information and information acquired by a camera mounted on the autonomous vehicle.

The vehicle position and orientation prediction unit predicts the current position information and heading information using a GPS and an IMU mounted on the autonomous vehicle.

The autonomous vehicle surrounding static object information return unit receives the static object information including road network information located within a predetermined distance from the autonomous vehicle.

The static object information preprocessing unit converts global coordinates of nodes and links included in the static object information into a coordinate system defined based on the current position and heading direction of the autonomous vehicle.

The static object information preprocessing unit represents the information of the nodes and the links as vectors of a predetermined dimension, and when the link is composed of a plurality of position points, separately generates a vector for each of the position points.

The static object information preprocessing unit determines attribute information that is considered helpful for occupancy grid map prediction when constructing the vector, and constructs the vector in consideration of the determination results regarding the attribute information.

The static object information preprocessing unit performs normalization on the vector using a predetermined constant.

The static object information preprocessing unit, when a length mismatch exists between the vectors of the nodes and links, adds elements to the relatively shorter vector to equalize the lengths of the vectors.

According to one embodiment, the occupancy grid map prediction unit predicts the occupancy grid map by simultaneously using a query map and the vectors of the nodes and the links as inputs.

According to another embodiment, the occupancy grid map prediction unit includes a layer into which the node and link vectors are input, and the query map, after passing through a self-attention layer, interacts with the node and link vectors through the layer, thereby acquiring static object information surrounding the autonomous vehicle from the nodes and links. The occupancy grid map prediction unit includes a node/link update transformer that uses the vectors of the nodes and the links as queries, keys, and values, and performs updates on the vectors based on the relationships among the nodes and the links.

The apparatus for generating a driving environment map for autonomous driving according to the present invention may further include a local path generation unit configured to receive an output from the occupancy grid map prediction unit and generate a local path for the autonomous vehicle, the local path being output in the form of waypoints indicating the route the autonomous vehicle should follow.

A method for generating a driving environment map for autonomous driving according to the present invention includes: predicting current position information and heading information of an autonomous vehicle using sensors mounted on the vehicle; receiving and returning static object information from a commercial navigation system based on a prediction result of the current position information and heading direction of the autonomous vehicle; performing preprocessing on the static object information received from the commercial navigation system; predicting an occupancy grid map using the preprocessed static object information and information acquired by a camera mounted on the autonomous vehicle; and generating a local path using a prediction output of the occupancy grid map.

The step of receiving and returning the static object information from the commercial navigation system based on the prediction result of the current position information and heading direction of the autonomous vehicle includes receiving the static object information including road network information located within a predetermined distance from the autonomous vehicle.

The step of performing preprocessing on the static object information received from the commercial navigation system includes; converting global coordinates of nodes and links included in the static object information into a coordinate system defined based on the current position and heading direction of the autonomous vehicle; and representing the information of the nodes and links as vectors of a predetermined dimension, wherein, when the link is composed of a plurality of position points, a separate vector is generated for each position point.

The step of performing preprocessing on the static object information received from the commercial navigation system includes; adding elements to the relatively shorter vector to equalize the lengths of the vectors when a length mismatch exists between the vectors of the nodes and links.

According to one embodiment, the step of predicting an occupancy grid map using the preprocessed static object information and the information acquired by a camera mounted on the autonomous vehicle comprises predicting the occupancy grid map by simultaneously using a query map and the node and link vectors as inputs.

According to another embodiment, the step of predicting an occupancy grid map using the preprocessed static object information and the information obtained through a camera mounted on the autonomous vehicle, includes: utilizing a layer into which the node and link vectors are input; acquiring static object information surrounding the autonomous vehicle; and predicting the occupancy grid map as a query map that has passed through a self-attention layer interacts with the node and link vectors through the layer. In this case, the step of predicting the occupancy grid map using the preprocessed static object information and the information acquired by a camera mounted on the autonomous vehicle includes: predicting the occupancy grid map by using a node/link update transformer, which uses the node and link vectors as a query, key, and value, and performs an update on the node and link vectors by utilizing the relationships between the node and link vectors; and an occupancy grid map prediction transformer, which receives the updated node and link vectors along with a query map and an image feature map as inputs, and generates a final predicted occupancy grid map.

According to the present invention, it is possible to more accurately predict static objects on a road by using road structure and attribute information provided by a commercial navigation system, together with sensing information acquired through the camera of the autonomous vehicle and other sensors, via an artificial neural network.

The effects of the present invention are not limited to those described above, and other effects not explicitly mentioned will be clearly understood by those skilled in the art from the following description.

### BRIEF DESCRIPTION OF DRAWINGS

FIG. 1 illustrates an example of an occupancy grid map (OGM).

FIG. 2 illustrates an example of an artificial intelligence technique for predicting an occupancy grid map using camera sensing information.

FIG. 3 illustrates a query map update process using a transformer.

FIG. 4 illustrates a driving environment map generation apparatus for autonomous driving according to an embodiment of the present invention.

FIG. 5 illustrates road network information including nodes and links.

FIG. 6 illustrates a configuration of an occupancy grid map prediction unit according to an embodiment of the present invention.

FIG. 7 illustrates a transformer structure utilizing link and node information according to an embodiment of the present invention.

FIG. 8 illustrates a transformer structure utilizing link and node information according to another embodiment of the present invention.

FIG. 9 illustrates a method for generating a driving environment map for autonomous driving according to an embodiment of the present invention.

FIGS. 10A to 10C illustrates an example of occupancy grid map prediction according to an embodiment of the present invention.

FIG. 11 is a block diagram of a computer system for implementing the method according to an embodiment of the present invention.

### DETAILED DESCRIPTION OF THE EMBODIMENTS

The above and other objects, advantages, and features of the present invention, and methods of achieving the same, will become apparent from the following detailed description of embodiments with reference to the accompanying drawings.

However, the present invention is not limited to the embodiments disclosed below, but may be implemented in various other forms. The following embodiments are provided merely to enable those skilled in the art to easily understand the objectives, configurations, and effects of the present invention, and the scope of the present invention is defined by the claims.

Meanwhile, the terminology used herein is intended to describe embodiments and is not intended to limit the scope of the present invention. As used herein, the singular forms also include the plural forms unless the context clearly indicates otherwise. It should also be understood that the terms “comprises” and/or “comprising,” as used in the specification, do not exclude the presence or addition of one or more other elements, steps, operations, and/or components.

Hereinafter, the background in which the present invention has been proposed will be described, followed by a description of embodiments of the present invention.

A general autonomous driving system (ADS) performs three main processing steps-perception, decision, and control—in order to enable full or partial autonomous operation of a vehicle.

First, in the perception process, static and dynamic objects surrounding the vehicle are detected using data acquired from various sensors, such as cameras and LiDAR. The positions of the objects are estimated or tracked. In addition, road structure information such as lane markings and surrounding buildings is recognized and compared with a high-definition (HD) map constructed with high precision, thereby enabling the prediction of the position and orientation (i.e., the ego-pose) of the autonomous driving vehicle (hereinafter referred to as “the autonomous vehicle”). The results of the perception process play an essential role in comprehending the overall driving situation for autonomous operation.

Next, in the decision process, multiple candidate paths that align with the driving intent of the autonomous vehicle are generated based on the information derived from the perception stage. The safety, efficiency, and other factors of each path are then analyzed to determine a final driving path.

Finally, in the control process, the steering angle and speed (throttle/brake) of the vehicle are controlled to enable the vehicle to actually drive along the selected path.

In the perception process, information regarding not only dynamic objects such as surrounding vehicles and pedestrians, but also static objects such as lane markings, traffic lights, and road signs, is utilized simultaneously. When such object information is represented in the form of an occupancy grid map (OGM), which is a grid-based representation format, its utility in the path generation and decision stages is enhanced. An occupancy grid map is generally a structure in which each cell on the map expresses, in a binary or probabilistic manner, whether it is occupied by a specific object, and is used as an intuitive and efficient spatial representation method in autonomous driving.

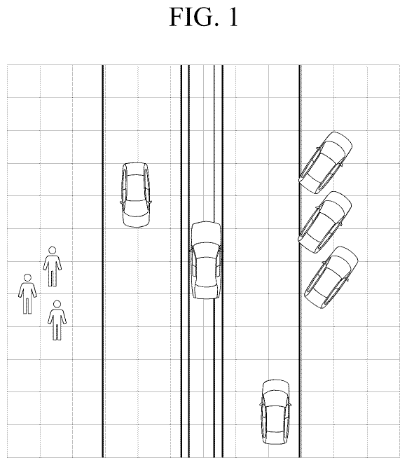

FIG. 1 illustrates an example of an occupancy grid map (OGM). The green vehicle represents the autonomous vehicle, and when an individual grid cell is predicted to be occupied by a specific object (e.g., a vehicle, pedestrian, etc.), the corresponding cell is assigned a specific value (e.g., 1 or 0). Through this representation, the driving environment surrounding the vehicle can be spatially visualized and utilized for subsequent path generation and other processes.

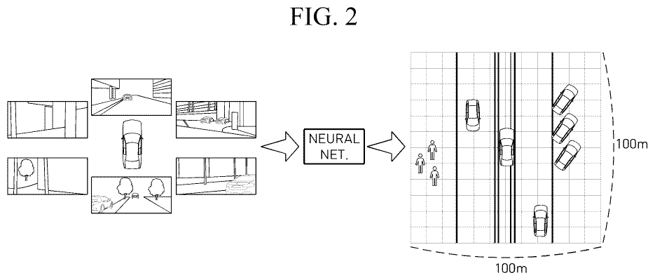

Recently, with the advancement of artificial intelligence technologies, various deep learning-based techniques have been proposed for directly predicting an occupancy grid map using sensing data acquired from sensors such as cameras. FIG. 2 illustrates an example of an artificial intelligence technique for predicting an occupancy grid map using camera sensing information.

The aforementioned artificial intelligence-based approaches may be classified into various methodologies depending on their structure or architecture, such as those based on fully convolutional networks or using Bird's Eye View (BEV) transformation.

The present invention proposes an apparatus and method for predicting an occupancy grid map using a transformer architecture based on a query map. The query map is a vector representation in the form of a spatial grid that can be used as input to the transformer, and may include various types of positional information and semantic context. According to an embodiment of the present invention, the transformer architecture centers on the use of a query map, but is not limited thereto and can be applied equally to various application methodologies that utilize the same structure, offering excellent scalability.

The images acquired from N cameras mounted on the vehicle are referred to as Iₙ∈R^{H}^{ₜ}^{×w}^{ₜ}^{×3}, n=1, . . . , N. Each image is passed through an image backbone deep network (e.g., ResNet) and is converted into an image feature map Fₙ∈R^{H}^{_{F}}^{×w}^{_{F}}^{×d} Next, a learnable query map corresponding to the occupancy grid map. Q∈R^{H×W×d} is randomly initialized. Here, H and W represent the number of query vectors corresponding to the height and width of the occupancy grid map, respectively. For example, as shown in FIG. 2, when both the width and height of the occupancy grid map are set to 100 meters, each query vector represents a grid corresponding to an area of

$$\frac{100}{H} \times \frac{100}{W}$$

square meters.

The query map and image feature maps are used as inputs to the transformer, and the transformer updates the query map using the image feature maps.

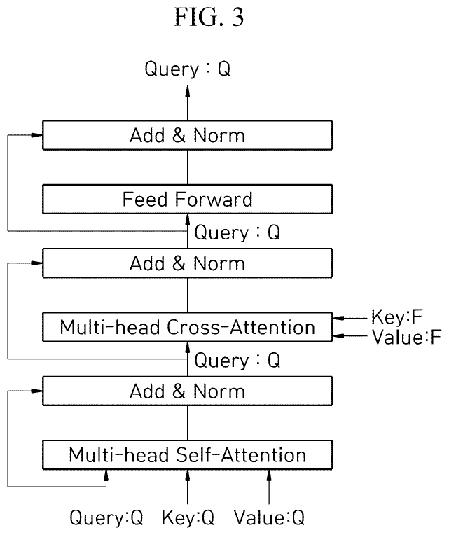

FIG. 3 illustrates a process of updating a query map using a transformer, and the process shown in FIG. 3 may be applied repeatedly.

The input data includes a query map (Q) and an image feature map (F). The query map is a grid-based representation for predicting the presence of objects and is composed of query vectors corresponding to individual grid cells. In this case, a positional embedding map may be added to both the query map and the image feature map in order to preserve the positional information of each element and to enable the transformer to understand the spatial structure.

For example, a Query Positional Embedding Map of the same size as the query map is defined as. PE_{Q}∈R^{H×W×d}. In this case, each Query Positional Embedding vector PE_{Q}(x)∈R^{d} (where x is the index coordinate within the map) is generated to be as orthogonal as possible in the vector space. The Query Positional Embedding vectors allow the transformer to easily distinguish between different query vectors (for example, Q(x)∈R^{d}, where x is the index coordinate within the map).

A positional embedding map having the same size as the image feature map is defined as PE_{K}∈R^{H}^{_{E}}^{×w}^{_{F}}^{×d}, and for each image feature map, the positional embedding map may be generated individually or the same map may be copied and used.

To obtain Ô∈R^{H×W×C} which is the prediction result of the occupancy grid map, a decoder module is applied to the query map that has been updated through the transformer. Here, C represents the number of types of dynamic and static objects to be predicted in the occupancy grid map. For example, if the occupancy grid map is intended to represent two classes (“vehicle” and “pedestrian”), then Cis set to 2.

The decoder module is configured such that upsampling, convolution, batch normalization, and ReLU activation are sequentially and repeatedly applied, and a sigmoid function is finally applied. As a result, the output value of Ô falls within a range between 0 and 1.

By using a predefined threshold value, it is possible to determine whether an object exists in a specific cell of the predicted occupancy grid map. For example, let \hat{Q}_{C}∈R^{H×W} denote the C-th channel of Ô∈R^{H×W×C}, where the map represents the occupancy grid map for “vehicles”. If the value \hat{Q}(x) at a specific location x in the map exceeds the predefined threshold, it is determined that a vehicle exists in the corresponding grid cell. Conversely, If Q(x) is below the threshold, it is determined that no vehicle is present in that grid cell.

The deep network is trained by computing the binary cross-entropy loss between a ground-truth occupancy grid map O_{GT}∈R^{H×W×C} and a predicted occupancy grid map Ô∈R^{H×W×C}, and minimizing the loss during the training process.

In the case of an autonomous driving system utilizing a high-definition (HD) map, since the structure of the road and lane information are pre-constructed with high precision, there is no need to separately represent elements such as a drivable area or lanes in the occupancy grid map (OGM). However, constructing HD maps for all roads nationwide and continuously maintaining and managing them requires significant time and financial resources. As a result, research on autonomous driving systems that do not rely on HD maps is ongoing.

In addition, even in autonomous driving systems that utilize high-definition maps, it is common for the shape of roads or lane structures to change in real time due to road construction, emergency response activities, or temporary lane changes. As a result, the existing HD maps may fail to reflect the current road conditions, which can lead to inaccurate or unstable autonomous driving decisions based on such outdated information. To address this issue, artificial intelligence-based technologies capable of dynamically recognizing the current road environment based on sensor data and reflecting it in real time are required. An example of such a technology is the occupancy grid map prediction method using a query map-based transformer, as described above.

There are several technical limitations in accurately predicting static objects on the road-such as drivable areas, lane markings, and crosswalks—in the form of an occupancy grid map using camera sensors mounted on autonomous vehicles. One of the primary limitations arises from the fact that the cameras typically mounted in autonomous vehicles do not support high resolution. This is because autonomous driving systems are generally required to perform perception, decision-making, and control computations in real time at approximately 10-millisecond intervals, and processing high-resolution images may increase the computational load, thereby compromising the system's overall real-time performance. Due to this constraint, it becomes impractical to mount high-resolution cameras, which in turn leads to reduced prediction accuracy for static objects located at a distance from the autonomous vehicle when relying on camera-based systems.

In addition, in occluded areas here the line of sight is blocked by other vehicles or objects surrounding the autonomous vehicle t is difficult to reliably determine the presence of static objects using only image information from camera sensors. This issue arises from the line-of-sight dependency of camera sensing, and additional technical approaches are required to overcome this limitation in order to ensure safe autonomous driving in complex traffic environments.

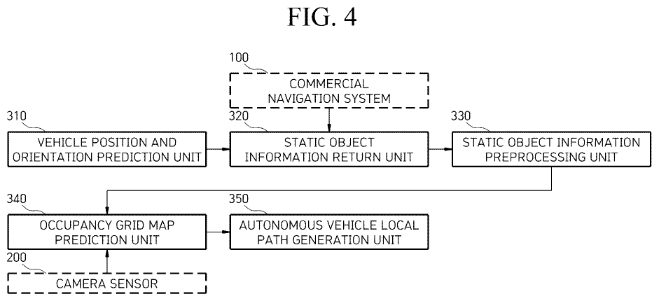

FIG. 4 illustrates a driving environment map generation apparatus for autonomous driving according to an embodiment of the present invention.

A driving environment map generation apparatus for autonomous driving according to an embodiment of the present invention generates a driving environment map by more accurately predicting static objects on the road using an artificial neural network based on road structure and attribute information provided by a commercial navigation system (100, with a typical positioning error of approximately 10 meters or more) and sensing information acquired through a camera sensor (200).

A vehicle position and orientation prediction unit (310) predicts the current position (i.e., global coordinate information) and heading direction of the autonomous vehicle using GPS and IMU data mounted on the vehicle

A static object information return unit (320) obtains static object information (e.g., lane markings, lanes, etc.) located within a certain distance from the autonomous vehicle, based on a map used by the commercial navigation system (100).

A static object information preprocessing unit (330) performs preprocessing on static object information acquired from a map used by the commercial navigation system (100), and the preprocessed information is used as input to a deep network.

The occupancy grid map prediction unit (340) predicts an occupancy grid map using a deep network, which is based on a query map-based transformer architecture as described above. Specifically, the deep network according to an embodiment of the present invention is designed on the assumption that it utilizes a query map as input and is based on a transformer structure that includes components such as multi-head self-attention, multi-head cross-attention, and positional embedding.

A local path generation unit (350) receives the occupancy grid map generated by the occupancy grid map prediction unit (340), generates a local path representing the route along which the autonomous vehicle should travel based on the map, and causes the vehicle to move according to the local path.

### The Static Object Information Return Unit Surrounding the Autonomous Vehicle (320)

The map information used by the commercial navigation system (100) includes road network information, which is composed of nodes (points) and links (polylines). Each of the nodes and links includes various attribute information along with global coordinate values.

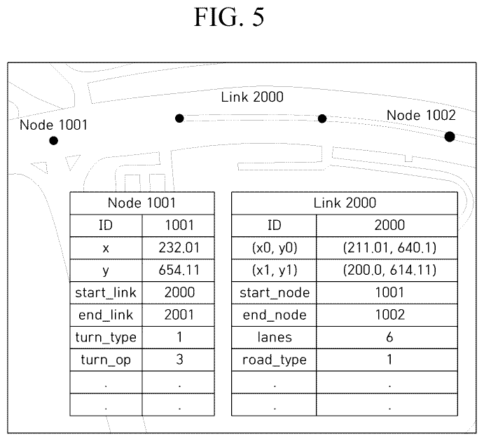

FIG. 5 illustrates road network information including nodes and links. A node refers to a point that separates links (i.e., the start or end point of a link), and a link refers to a line representing a road centerline, which is generated by offsetting the connection between two nodes at regular intervals in the direction of travel. Each node and link includes connection information, such as which node a specific link starts from and ends at, and whether a specific node serves as the start or end point of a particular link. The attribute information includes various data such as the type of the node or link, the number of lanes, and the maximum speed limit.

The surrounding static object information return unit (320) collects and returns all node and link information located within a certain distance from the current position (i.e., global coordinate information) of the autonomous vehicle, which is received from the vehicle position and orientation prediction unit (310).

### The Static Object Information Preprocessing Unit (330)

The static object information preprocessing unit performs preprocessing on the node and link information surrounding the autonomous vehicle, which is received from the surrounding static object information return unit, and uses the preprocessed information as input to the deep network.

The static object information preprocessing unit (330) converts the global coordinates of the nodes and links into a local coordinate system that is defined based on the current position and heading direction of the autonomous vehicle, i.e., an ego-centric coordinate system.

As a result of the transformation, the current position of the autonomous vehicle is set to the origin (0, 0), the forward-facing direction of the vehicle becomes the longitudinal direction, and the left-hand direction of the vehicle becomes the lateral direction.

The static object information preprocessing unit (330) represents the node and link information as one-dimensional vectors. In the case of a node illustrated in FIG. 5, the node is represented as a one-dimensional vector by sequentially arranging its associated information, such as N=[1001, 30.2, −100.0, 2000, 2001, 1, 3, . . . ]. The second and third elements of N, 30.2 and −100.0 are values obtained by converting the global coordinate (232.01, 654.11) of the node into the ego-centric coordinate system.

The static object information preprocessing unit (330) also generates a one-dimensional vector for a link by sequentially arranging its associated information, similar to the node. When a single link is composed of a plurality of position points, a separate vector is generated for each position point. For example, in the case of the link illustrated in FIG. 5, which consists of position points (x₀, y₀) and (x₁, y₁), two vectors, \vec{L₀}=[2000, 12.2, −132.0, 1001, 1002, 6, 1, . . . ] and \vec{L₁}=[2000, 10.2, −130.0, 1001, 1002, 6, 1, . . . ] are generated.

The values 12.2 and −132.2 of \vec{L₀} are obtained by converting the coordinates (x₀, y₀) of the link into the ego-centric coordinate system, and the values 10.2 and −130.2 of \vec{L₁} are obtained by converting the coordinates (x₁, y₁) of the link.

The static object information preprocessing unit (330) normalizes the node and link vectors using a predetermined constant. For example, assuming that the predetermined constant T is 1000, all elements of the link and node vectors are divided by T. This normalization process prevents the values of the vector elements from becoming excessively large, which could interfere with the training of the deep network.

The static object information preprocessing unit (330) does not necessarily use all attribute information when constructing the node and link vectors. The static object information preprocessing unit (330) preselects attribute information that is determined to be useful for the prediction by the deep network, and constructs the node and link vectors based on such determination.

When a length mismatch exists between the vector representations of nodes and links, the static object information preprocessing unit (330) normalizes all vectors to the same length in order to ensure consistency in vector operations. This is accomplished by adding interpolation or padding elements with arbitrary values to the shorter vector. The added elements may have either fixed or random values.

### The Occupancy Grid Map Prediction Unit (340)

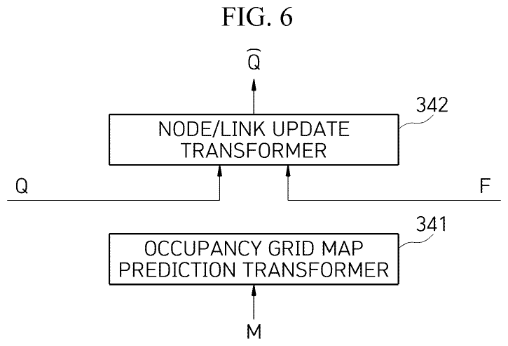

FIG. 6 illustrates the configuration of the occupancy grid map prediction unit (340) according to an embodiment of the present invention, and shows the structure of a deep network that utilizes link and node information. Referring to FIG. 6, Q denotes the query map, Fₙ, n=1, . . . , N. denotes the image feature map, and M=[\vec{N₀}, . . . , \vec{N_{P}}, \vec{L₁}, . . . , \vec{L_{T}} ] denotes the previously generated node and link vectors.

Each vector in M is passed through a multi-layer perceptron (MLP) and transformed into a vector having a dimension of d. Accordingly, the resulting matrix has a size of (P+T)×d.

The node/link update transformer (341) is a transformer that uses M as the query, key, and value, and is characterized by comprising a single self-attention layer and a feed-forward network. It performs an update on M by utilizing the relationships among all links and nodes within M.

The occupancy grid map prediction transformer (342) receives the updated node and link vectors, along with the query map and image feature map, as inputs, and generates the final predicted occupancy grid map Ô∈R^{H×W×C}.

The occupancy grid map prediction transformer (342) may be configured with the same structure as that illustrated in FIG. 3, or may be designed by adding a separate cross-attention layer to the structure shown in FIG. 3.

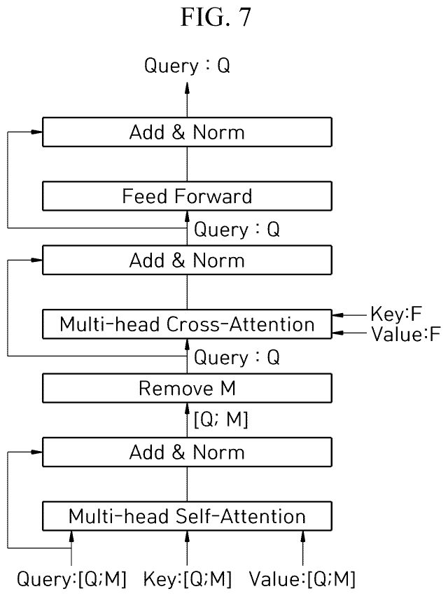

A deep network structure that predicts an occupancy grid map by additionally utilizing M in a transformer having the same structure as that illustrated in FIG. 3 is shown in FIG. 7. FIG. 7 illustrates a transformer structure that utilizes link and node information according to an embodiment of the present invention.

In the structure illustrated in FIG. 3, only Q is used as the input to the self-attention layer. In contrast, in the transformer structure according to an embodiment of the present invention, both Q and M are used simultaneously as inputs (i.e., [Q; M]∈R^{(H×W+P+T)×d}), allowing interactions between Q and M to occur. In this structure, the node/link update transformer (341) is not used separately.

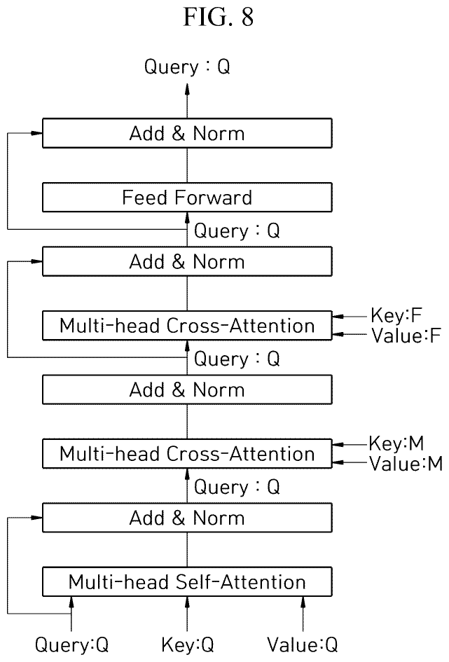

FIG. 8 illustrates a transformer structure that utilizes link and node information according to another embodiment of the present invention.

When a separate cross-attention layer is configured in the structure illustrated in FIG. 3, Q, after passing through the self-attention layer, interacts with M through the subsequent cross-attention layer to acquire static object information surrounding the autonomous vehicle from the nodes and links.

### The Autonomous Vehicle Local Path Generation Unit (350)

The output value OGM Ô∈R^{H×W×C} of the occupancy grid map prediction unit (340) is delivered to the local path generation unit (350) and is utilized for generating a local path for the autonomous vehicle. A separate deep network may additionally be used during local path generation. For example, when the occupancy grid map is provided as input along with the current pose, position, and velocity information of the autonomous vehicle, a deep network may be separately configured to output the path the vehicle should follow in the form of waypoints.

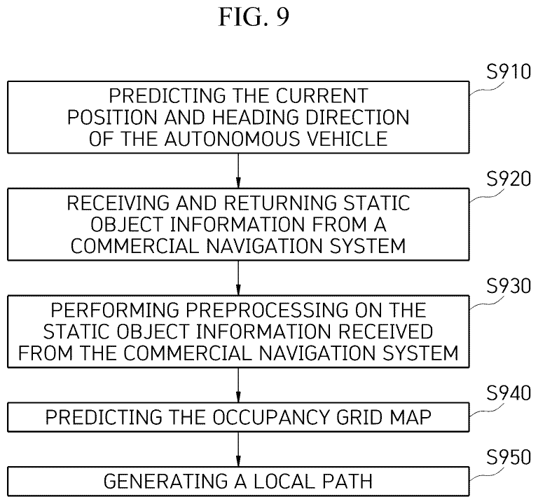

FIG. 9 illustrates a method for generating a driving environment map for autonomous driving according to an embodiment of the present invention.

A method for generating a driving environment map for autonomous driving according to an embodiment of the present invention includes: a step (S910) of predicting the current position and heading direction of the autonomous vehicle using sensors mounted on the vehicle; a step (S920) of receiving and returning static object information from a commercial navigation system based on the predicted current position and heading direction of the autonomous vehicle; a step (S930) of performing preprocessing on the static object information received from the commercial navigation system; a step (S940) of predicting an occupancy grid map using the preprocessed static object information and information acquired by a camera mounted on the autonomous vehicle; and a step (S950) of generating a local path using the prediction output of the occupancy grid map.

In the step (S920) of receiving and returning static object information from a commercial navigation system based on the predicted current position and heading direction of the autonomous vehicle, static object information including road network information located within a predetermined distance from the autonomous vehicle is received.

In the step (S930) of performing preprocessing on the static object information received from the commercial navigation system, the global coordinates of the nodes and links included in the static object information are converted into a coordinate system defined based on the current position and heading direction of the autonomous vehicle. The information of the nodes and links is represented as vectors of a predetermined dimension, and when a link is composed of a plurality of position points, a separate vector is generated for each position point.

In the step (S930) of performing preprocessing on the static object information received from the commercial navigation system, when a length mismatch exists between the vectors of the nodes and links, elements are added to the relatively shorter vector to equalize the lengths of the vectors.

According to one embodiment, in the step (S940) of predicting the occupancy grid map using the preprocessed static object information and the information acquired by a camera mounted on the autonomous vehicle, the occupancy grid map is predicted by simultaneously using the query map and the node and link vectors as inputs.

According to another embodiment, in the step (S940) of predicting the occupancy grid map using the preprocessed static object information and the information acquired by a camera mounted on the autonomous vehicle, a layer into which the node and link vectors are input is utilized. The query map, after passing through a self-attention layer, interacts with the node and link vectors through the layer, thereby acquiring static object information surrounding the autonomous vehicle and predicting the occupancy grid map. In this case, a node/link update transformer is employed, which uses the node and link vectors as queries, keys, and values, and performs updates on the node and link vectors based on their relationships. An occupancy grid map prediction transformer is then used to generate the final predicted occupancy grid map, receiving the updated node and link vectors along with the query map and the image feature map as inputs.

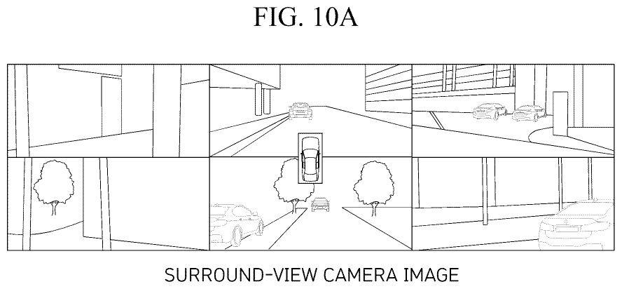

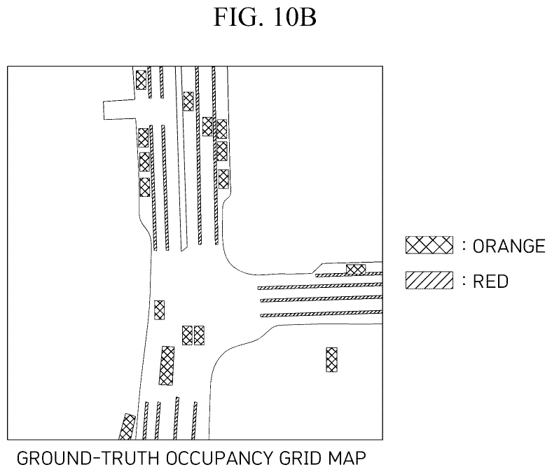

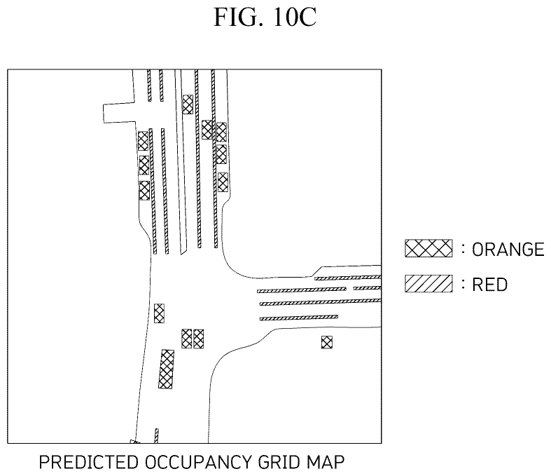

FIGS. 10A to 10C illustrates an example of occupancy grid map prediction according to an embodiment of the present invention.

FIG. 10A illustrates an image (surround-view camera image) acquired from the vehicle's camera, FIG. 10B illustrates a ground-truth occupancy grid map, and FIG. 10C illustrates a predicted occupancy grid map generated by the deep network-based occupancy grid map prediction unit according to an embodiment of the present invention.

In the occupancy grid map, the region shown in orange represents a vehicle, the region shown in blue represents a pedestrian, the region shown in gray represents a drivable area, and the region shown in red represents a lane. As illustrated in FIG. 10, even in a situation where the right-side portion of the road is not fully visible from the perspective of the autonomous vehicle, it can be observed that the deep network is capable of predicting the road structure and lane information with relatively high accuracy.

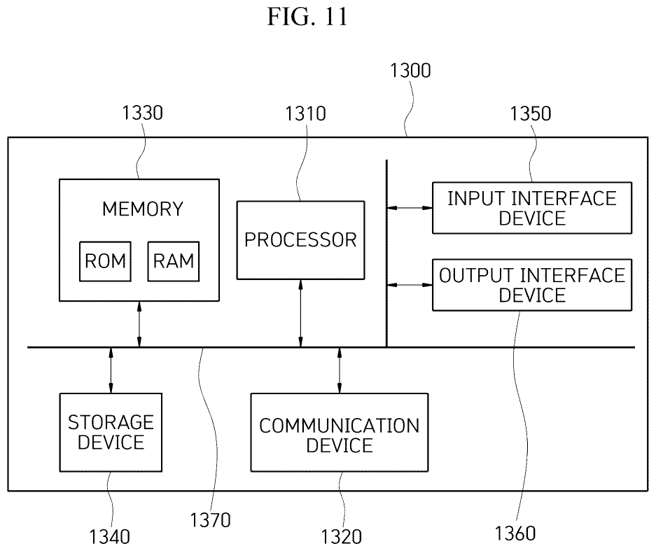

FIG. 11 is a block diagram illustrating a computer system for implementing the method according to an embodiment of the present invention.

Referring to FIG. 11, a computer system (1300) may include at least one of a processor (1310), a memory (1330), an input interface device (1350), an output interface device (1360), and a storage device (1340), all of which communicate via a bus (1370). The computer system (1300) may also include a communication device (1320) coupled to a network. The processor (1310) may be a central processing unit (CPU) or a semiconductor device that executes instructions stored in the memory (1330) or the storage device (1340). The memory (1330) and the storage device (1340) may include various types of volatile or non-volatile storage media. For example, the memory may include a read-only memory (ROM) and a random-access memory (RAM). In the embodiment described herein, the memory may be located inside or outside the processor and may be connected to the processor using any of a variety of known means. The memory comprises various types of volatile or non-volatile storage media, and for example, may include read-only memory (ROM) or random-access memory (RAM).

Accordingly, an embodiment of the present invention may be implemented as a computer-implemented method or as a non-transitory computer-readable medium having computer-executable instructions stored thereon. In one embodiment, when executed by a processor, the computer-readable instructions may perform a method according to at least one aspect of the present disclosure.

The communication device (1320) may transmit or receive wired or wireless signals.

Additionally, the method according to an embodiment of the present invention may be implemented in the form of program instructions that can be executed through various computer means, and may be recorded on a computer-readable medium.

The computer-readable medium may include, alone or in combination, program instructions, data files, data structures, and the like. The program instructions recorded on the computer-readable medium may be specially designed and configured for an embodiment of the present invention, or may be known and available to those skilled in the field of computer software. The computer-readable recording medium may include hardware devices configured to store and execute program instructions. For example, the computer-readable recording medium may include magnetic media such as hard disks, floppy disks, and magnetic tapes; optical media such as CD-ROMs and DVDs; magneto-optical media such as floptical disks; and semiconductor memory devices such as ROM, RAM, and flash memory. The program instructions may include not only machine code generated by compilers but also high-level language code that can be executed by a computer using an interpreter or the like.

While the embodiments of the present invention have been described in detail above, the scope of the present invention is not limited thereto. Various modifications and alterations made by those skilled in the art based on the basic concept of the invention defined in the following claims also fall within the scope of the present invention.

What is claimed is:

1. A driving environment map generation apparatus for autonomous driving, comprising:
a vehicle position and orientation prediction unit configured to predict current position information and heading direction of an autonomous vehicle using sensors mounted on the autonomous vehicle;
an autonomous vehicle surrounding static object information return unit configured to receive static object information from a commercial navigation system;
a static object information preprocessing unit configured to perform preprocessing on the static object information; and
an occupancy grid map prediction unit configured to predict an occupancy grid map using the preprocessed static object information and information acquired by a camera mounted on the autonomous vehicle.

2. The driving environment map generation apparatus for autonomous driving according to claim 1,
wherein the vehicle position and orientation prediction unit predicts the current position information and heading information using a GPS and an IMU mounted on the autonomous vehicle.

3. The driving environment map generation apparatus for autonomous driving according to claim 1,
wherein the autonomous vehicle surrounding static object information return unit receives the static object information including road network information located within a predetermined distance from the autonomous vehicle.

4. The driving environment map generation apparatus for autonomous driving according to claim 1,
wherein the static object information preprocessing unit converts global coordinates of nodes and links included in the static object information into a coordinate system defined based on the current position and heading direction of the autonomous vehicle.

5. The driving environment map generation apparatus for autonomous driving according to claim 4,
wherein the static object information preprocessing unit represents the information of the nodes and links as vectors of a predetermined dimension, and generates a separate vector for each position point when the link is composed of a plurality of position points.

6. The driving environment map generation apparatus for autonomous driving according to claim 5,
wherein the static object information preprocessing unit determines attribute information that is considered helpful for occupancy grid map prediction when constructing the vector, and constructs the vector based on the determination regarding the attribute information.

7. The driving environment map generation apparatus for autonomous driving according to claim 5,
wherein the static object information preprocessing unit performs normalization on the vector using a predetermined constant.

8. The driving environment map generation apparatus for autonomous driving according to claim 5,
wherein the static object information preprocessing unit, when a length mismatch exists between the vectors of the nodes and links, adds elements to the relatively shorter vector to equalize the lengths of the vectors.

9. The driving environment map generation apparatus for autonomous driving according to claim 5,
wherein the occupancy grid map prediction unit predicts an occupancy grid map by simultaneously using a query map and the node and link vectors as inputs.

10. The driving environment map generation apparatus for autonomous driving according to claim 5,
wherein the occupancy grid map prediction unit comprises a layer into which the node and link vectors are input, and the query map, after passing through a self-attention layer, interacts with the node and link vectors through the layer, thereby acquiring static object information surrounding the autonomous vehicle from the nodes and links.

11. The driving environment map generation apparatus for autonomous driving according to claim 10,
wherein the occupancy grid map prediction unit comprises a node/link update transformer that uses the node and link vectors as queries, keys, and values, and performs updates on the node and link vectors based on relationships among the nodes and links.

12. The driving environment map generation apparatus for autonomous driving according to claim 1, further comprising:
an autonomous vehicle local path generation unit configured to receive an output from the occupancy grid map prediction unit and generate a local path for the autonomous vehicle, the local path being output in the form of waypoints indicating the route the autonomous vehicle should follow.

13. A method for generating a driving environment map for autonomous driving, performed by a driving environment map generation apparatus for autonomous driving, the method comprising:
predicting current position information and heading direction of an autonomous vehicle using sensors mounted on the autonomous vehicle;
receiving static object information from a commercial navigation system based on a prediction result of the current position information and heading direction of the autonomous vehicle;
performing preprocessing on the static object information received from the commercial navigation system;
predicting an occupancy grid map using the preprocessed static object information and information acquired by a camera mounted on the autonomous vehicle; and
generating a local path using a prediction output of the occupancy grid map.

14. The method according to claim 13,
wherein the step of receiving static object information from the commercial navigation system based on the prediction result of the current position information and heading direction of the autonomous vehicle includes receiving the static object information including road network information located within a predetermined distance from the autonomous vehicle.

15. The method according to claim 13,
wherein the step of performing preprocessing on the static object information received from the commercial navigation system comprises:
converting global coordinates of nodes and links included in the static object information into a coordinate system defined based on the current position and heading direction of the autonomous vehicle; and
representing the information of the nodes and links as vectors of a predetermined dimension, wherein, when a link is composed of a plurality of position points, a separate vector is generated for each position point.

16. The method according to claim 15,
wherein the step of performing preprocessing on the static object information received from the commercial navigation system comprises:
adding elements to the relatively shorter vector to equalize the lengths of the vectors when a length mismatch exists between the vectors of the nodes and links.

17. The method according to claim 15,
wherein the step of predicting the occupancy grid map using the preprocessed static object information and the information acquired by a camera mounted on the autonomous vehicle comprises predicting the occupancy grid map by simultaneously using a query map and the node and link vectors as inputs.

18. The method according to claim 15,
wherein the step of predicting the occupancy grid map using the preprocessed static object information and the information acquired by a camera mounted on the autonomous vehicle comprises:
utilizing a layer into which the node and link vectors are input; and
acquiring static object information surrounding the autonomous vehicle and predicting the occupancy grid map as a query map that has passed through a self-attention layer interacts with the node and link vectors through the layer.

19. The method according to claim 18,
wherein the step of predicting the occupancy grid map using the preprocessed static object information and the information acquired by a camera mounted on the autonomous vehicle comprises:
using a node/link update transformer that uses the node and link vectors as a query, key, and value, and performs an update on the node and link vectors by utilizing relationships among them; and
predicting the occupancy grid map using an occupancy grid map prediction transformer that receives, as inputs, the updated node and link vectors, a query map, and an image feature map, and generates a final predicted occupancy grid map.
